(19) United States
(12) Patent Application Publication
(10) Pub. No.: US 2010/0313151 A1
(43) Pub. Date: Dec. 9, 2010

(54) REPRESENTING DATA ON CONFIGURABLE TIMELINE WITH FILTER

(75) Inventors: Ming Wei, Beijing (CN); Wei Peng, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/478,430

(22) Filed: Jun. 4, 2009

(51) Int. Cl. G06F 3/048

(52) U.S. Cl. 715/764

(57) ABSTRACT

In one example, medical records or other types of data may be shown on a configurable timeline. The particular way in which data is organized on the timeline (e.g., by year, by quarter, by month, etc.) may be configured by a user. The timeline may support two levels of chronological organization (referred to as “groups” and “slots”), where the data is placed on the timeline according to both its group and its slot. For example, if a group is a calendar year and a slot is a calendar quarter, the data may be placed on the timeline in a way that visually shows both the year and the quarter to which the data relates. The data may be filtered according to a configurable filter, so that data records are shown, or not shown, on the timeline depending on whether the records satisfy the filtering criteria.

### BACKGROUND

There are situations in which data is to be shown on a timeline. For example, medical data, financial data, sports data, etc., may represent some chronology of events, and thus there may be reason to show the data visually in the form of a timeline.

Various software packages can organize data chronologically. For example, spreadsheets and databases can sort data by date and/or time, and can prepare simple graphs based on the data. However, the capabilities of these software packages may be inadequate for certain purposes, and may lack the configurability that would allow the data to be shown in a particular manner.

### SUMMARY

A timeline may be used to show data. Moreover, the timeline may be configurable, so as to allow a user to choose the way in which data is to be shown on the timeline, and to choose the particular filters that are applied to the data.

A user may choose different levels of organization for the timeline, which may be referred to as groups and slots. A group may define a particular chronological range of data (e.g., a decade, a year, a month, etc.), or some other non-time-based range of data (e.g., data produced by a particular person or groups of peoples). A slot may define a particular sub-range of a group (e.g., if a group is a calendar year, then slot might be a calendar quarter). Or, a slot could be a sub-division of a group that is based on something other than a sub-range of time: e.g., if a group represents a year, then a slot could represent the data records associated with a particular team of people. Moreover, the user may choose a filter. Thus, if there are several different kinds of data, and the user wants to see only specific kinds of data on the timeline, the user can define a filter that allows only certain kinds of data—but not others—to be shown on the timeline. The data are then shown on the timeline organized by the groups and slots that the user has defined, and the specified filter may be used to select which data will be shown on the timeline.

For example, if the data are records of medical tests performed on a particular patient, a hospital technician might want to see the chronology of the patient's history of tests, organized by year and quarter. Each different type of test could be assigned a particular symbol for the timeline (e.g., a box of a particular color). The user could define slots as being calendar quarters, and groups as being calendar years. Thus, each slot could be assigned a column on the timeline, and each year could be represented as four columns (representing the four different quarters of each year). Each column could show boxes of various colors, representing the different tests that a patient underwent in a particular quarter. A filter might be defined so that some types of tests would appear on the timeline and others would not—e.g., a user could ask to see only Computerized Tomography (CT) scans, but not Magnetic Resonance (MR) scans. In such an example, only the boxes representing the CT scans would be shown on the timeline, but the boxes representing MR scans would not be shown. The user could drill down into the details of a particular test by clicking the box on the timeline that represents the test.

The view of the data that is shown on the timeline, and the underlying data itself, may be decoupled by using separate data models and view models. The data model defines the underlying representation of the data, while the view model interacts with a user interface (UI) engine to determine how the data is displayed and how the user may affect (or otherwise interact) with that data. The view model may support different timeline views of the same underlying data. E.g., the view model could support the display of a full timeline, and also could support the display of a mini timeline that represents a relatively more compact visual representation of the data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a first example user interface in which a timeline may be presented.

FIG. 2 is a block diagram of a second example user interface in which a timeline may be presented.

FIG. 3 is a block diagram of an example system in which a timeline may be used to show data.

FIG. 4 is a block diagram of an example container structure.

FIG. 5 is a flow diagram of an example process in which a timeline may be configured and/or shown.

FIG. 6 is a block diagram of example components that may be used in connection with implementations of the subject matter described herein.

### DETAILED DESCRIPTION

There are many situations in which data is to be shown on a timeline. For example, in the field of medical data, patients are treated over a period of time. At various points in time, a patient may undergo certain tests, treatments, laboratory procedures, etc. A clinician may want to view the patient's course of treatment, or certain aspects of that treatment, during particular periods of time. Medicine is one field in which there may be reason to view data on a timeline, although there are other such fields—e.g., finance, automotive repair, sports, to name a few examples.

Many software packages are able to work, in some way, with data that has a time component. For example, if a record in a spreadsheet or database contains field(s) for date and/or time, the spreadsheet or database may be able to sort the data records in chronological order. Applications that are built on top of spreadsheets or databases (e.g., personal or business accounting software) may be able to present a date- or time-driven view of data by using the underlying capabilities of the spreadsheet or database. However, the ability to view, and to work with, data on a timeline tends to be limited narrowly by the capabilities of the underlying software. For example, a spreadsheet can present a table of records in an order, or can prepare some basic charts or graphs based on the data. However, these capabilities may be insufficient to allow a user to work with data in certain ways, or to present certain kinds of views of the data.

The subject matter herein may be used to present a timeline view of data to the user. The timeline is configurable in the sense that it allows a user to work with the data in containers that exist at various levels. Additionally, various different filters may be applied to the data. For example, one level of container may be a year container, in which data is classified by year. Another level of container may be a quarter container in which the same data is classified by quarters of a year. The particular range of time covered by each level of container is configurable—e.g., one user might choose to group data by year and quarter, while another user might choose to group data by month and day. Additionally, data can be filtered. For example, in a medical setting, a user might choose to see all medical tests performed on a patient in a given year, while another user might choose to see only blood tests and X-rays performed on that patient. A filter may be defined that determines which data appears on the timeline.

The implementation of a timeline may use two different models: a data model and a view model. The data model defines the structure of the underlying data that appears on the timeline. The view model defines how the data will be presented and filtered. An interactive user interface (UI) is bound to the view model, so actions taken by a user that affect how the data is to be presented can make changes to the view model without changing the underlying data model that the view model is designed to present. For example, if the user adds new filters, or changes the range of data that is to be seen, these actions by the user affect the view model without affecting the underlying data.

The timeline may be presented using a UI engine, such as Windows Presentation Framework (WPF). However, the timeline could be presented in any way.

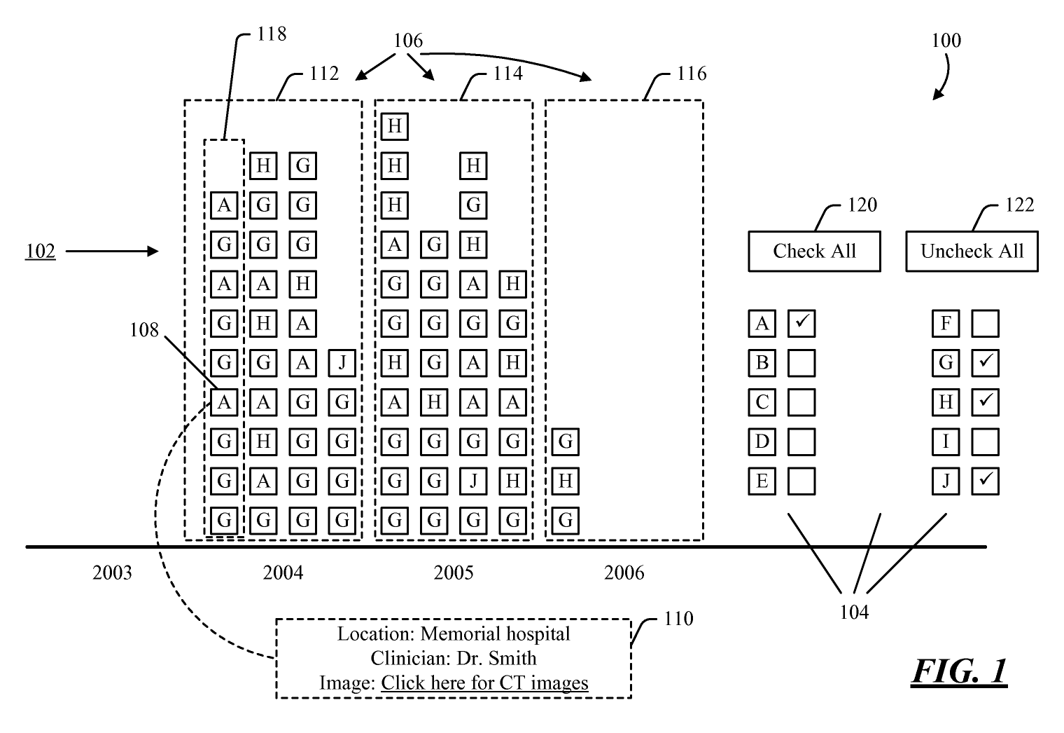

Turning now to the drawings, FIG. 1 shows an example user interface 100 in which a timeline 102 may be presented. In the example of FIG. 1, timeline 102 shows medical data, in particular, data relating to medical tests given to a patient. These tests may describe physical procedures that have been performed on a patient's human body, or that are used in the course of making physical diagnosis and/or treatment of conditions of the patient's human body. However, FIG. 1 is merely an example, and any type of data could be shown on a timeline (of which the above-mentioned data relating to finance, automotive repair, or sports are some non-limiting examples).

In example timeline 102, various different types of medical tests are shown. Each of the medical tests may have a specific color code. Due to the nature of FIG. 1 as a black-and-white line drawing, each of the tests is shown by a box with a specific letter, although it will be understood that, on a color computer screen, each test could be represented by a square having a particular color. In the example, there is a key 104 which shows which letter corresponds to a given test (and, it will be understood, on a computer screen, key 104 could show which color corresponds to a given tests). Thus, box “A” represents a Computed Tomography (CT) scan, box “B” represents a Magnetic Resonance (MR) scan, and so on.

Each test that is given may be associated with a particular data record. The data record may contain various information, such as the results of the test, the clinician who performed the test, the facility at which the test was administered, etc. With regard to timeline 102, one piece of data that may be contained in each record is the date on which the test was given, and the timeline may be constructed from this type of data. The data in each record may be represented in the manner called for by the data model.

Timeline 102 shows, in graphical form, which tests were given to a specific patient, and when those tests were given. For example, in key 104, box “A” represents a CT test. Each occurrence of box “A” within data 106 indicates a specific time that a CT test was given to the patient. User interface 100 may be interactive in the sense that a user can click on a particular box, which may reveal the contents of the data record. Thus, if a user clicks on a particular box 108 (which represents a particular instance of a CT test), then user interface 100 may show to the user detail 110 of the record of that test. In the example shown in FIG. 1, that detail includes a location at which the test was administered, the name of a clinician who administered the test, and a link to the images captured by the CT test.

Timeline 102 allows the records of various tests to be represented chronologically. Thus, group 112 of data records represents the records of tests given in a specific year (year 2004), and groups 114 and 116 represent the records of tests given in years 2005 and 2006, respectively. Within each group, the data may be further sub-divided by chronology. Thus, in the example of timeline 102, slot 118 represents the records of tests given in the first quarter of year 2004. Each quarter may have its own slot.

In general, “group” and “slot” are example terms that may be used to refer to different levels of detail in the chronology. Or, alternatively, groups and/or slots could be defined based on something other than chronology—e.g., a group could encompass data records generated by a particular organization, and each slot could be data records generated by a particular person in the organization. In general, a group could represent one category of data and a slot could represent another category of data. A time range is one example of a category (but not the only example; organizing data on the timeline by person, or by some other non-chronological characteristic, is another example of organizing data by category). In one specific example, a group is defined based on the chronology of the data, and a slot is defined based on some characteristic of the data other than chronology. The fact that the data may be categorized chronologically by both group and slot may be referred to as the “multi-level” nature of timeline 102. In example timeline 102, each group is a calendar year, and each slot is a calendar quarter of a particular year contained within a given group. However, groups and slots could be defined in other ways. For example, a group could be a week, and a slot could be a particular day of each week. One way in which timeline 102 may be configurable is that the ranges of time represented by groups and slots may be user-defined. There may be some default setting for groups and slots (e.g., group=calendar year, slot=calendar quarter), but a user could re-define these settings. If the user re-defines the settings, then the new settings may become part of the view model for the timeline, and the way in which data records are shown on the timeline may be changed accordingly. For example, if the user sets group=week and slot=day, then the bottom of timeline 102—instead of showing years 2002, 2003, etc.—may show weeks 1, 2, 3, etc., with each column of data records representing a particular day of the week. In general, the timeline may show data in a manner that reflects the particular group and/or slot that the date associated with a given data record falls into. Showing years on a timeline, and showing different columns for the quarters of the year, is one example way in which the timeline can visually reflect the group/slot of the various data records.

The meaning of groups and slots is one aspect of timeline 102 that may be configurable by a user. Another aspect is the particular selection of tests that are to be shown on timeline 102. For example, in key 104 it is shown that the tests represented by boxes “A”, “G”, “H”, and “J” will be displayed on timeline 102, and that other tests will not to be displayed. This choice is represented by check boxes next to those tests that are to be shown. User interface 100 may provide various controls that allow the user to define the particular filter to be used. For example, the user could check boxes individually, and/or could be provided with “check all” and “uncheck all” buttons 120 and 122. In the example of FIG. 1, the filter is defined by the user's indication of which tests he or she wants to see, and which ones he or she does not want to see. However, a filter could be defined in any manner. For example, a user could define a filter that shows only those tests administered by a particular clinician, or at a particular hospital; or the user could define any other filtering criteria.

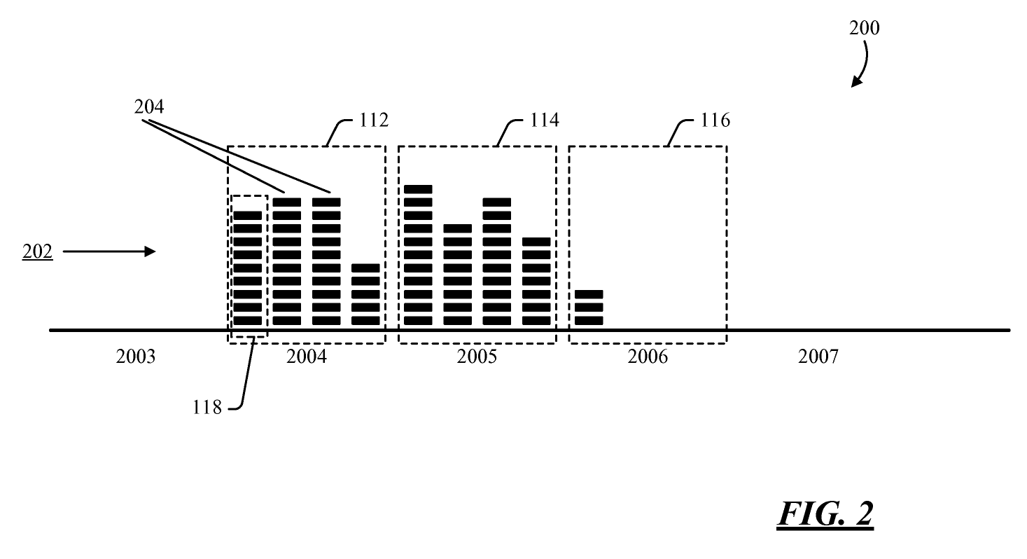

FIG. 2 shows an example of an alternative user interface 200 that may be used to present a timeline 202. Timeline 202 may be considered a “mini-timeline”, in the sense that it represents a smaller version of timeline 102, possibly at a lower-level of detail. Like timeline 102 (shown in FIG. 1), timeline 202 divides records into groups 112, 114, and 116, and slots (e.g., slot 118) based on the times associated with those data records. However, in timeline 202, each data record is represented by a smaller marker 204 (each marker being represented by one of the thick, solid horizontal lines that are stacked in columns on timeline 202), thereby allowing the same events to be shown in a smaller amount of space. For example, timeline 102 could be a “full screen” view of events, and timeline 202 could be the size shown in a reduced window.

Timelines 102 and 202 are generated from the same underlying data model. That is, the records that are represented on timelines 102 and 202 may be the same set of records. However, the view model may provide for two different views of the same data, where timeline 102 is one view of the data, and timeline 202 is a different view of the same data.

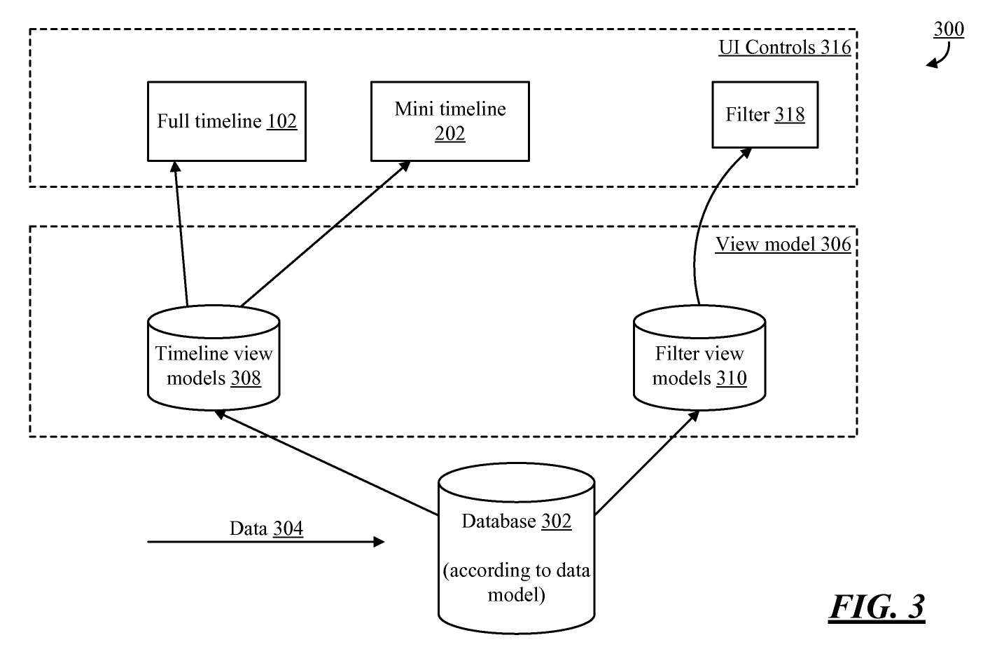

FIG. 3 shows an example system 300 in which a timeline may be used to show data 304. Data 304 is stored in database 302. The structure of the data 304, and relationships among the data 304, satisfy a particular data model. For example, if data 304 is medical data, then database might store lists of patients, clinicians, hospitals, specific tests that have been performed, etc. The actual data 304 that is in database 302 at any time may be data that was entered into database 302 or captured from some source. For example, when a test is performed, a record of the test may be entered into database 302. Or, database 302 could receive a set of data records from another database. Moreover, various events may affect the data stored in database 302. For example, certain tests results might expire with the passage of time, so the passage of the expiration date may cause a test record to become invalid. Expiration is thus an example of an event that may affect the content of database 302.

View model 306 serves as a bridge between the data model and the user interface engine. View model 306 contains logic to implement timelines and filters. For example, view model 306 may include one or more timeline view models 308 and one or more filter view models 310. Timeline view models 308 may include logic that implements one or more timeline views. Continuing with the medical test example introduced above, given some underlying data about medical tests that have been performed, a UI engine may use timeline view models 308 to display either a full or mini timelines. In this way, the way in which data is visually presented to the user is decoupled from the underlying data itself.

Filter view models 310 provide various different filters that affect the way in which data is shown on a timeline. As discussed above in connection with FIGS. 1 and 2, data may be filtered according to certain criteria. For example, a filter may be used to select certain medical tests to be shown (as in the timeline of FIG. 1), or to select tests performed at a certain hospital, or tests performed by a certain clinician, etc. These filters may be implemented as part of filter view models 310. The filters may affect what data is shown to a user.

UI controls 316 may be implemented through a UI rendering engine, such as WPF. UI controls 316 may use the timeline view models 308 and filter view models 310 to display a timeline in a particular way, and to apply a filter that determines which data are shown on the timeline. Thus, in the example of FIG. 3, UI controls 316 may display full timeline 102 or mini timeline 202. UI controls 316 may use timeline view models 308 to display a particular kind of timeline view. Additionally, UI controls 316 may use filter view models 310 to determine how to filter the data (at 318). Thus, UI controls 316 can interact with underlying data to show a particular timeline (in full or mini format), with filtered results, by using view model 306.

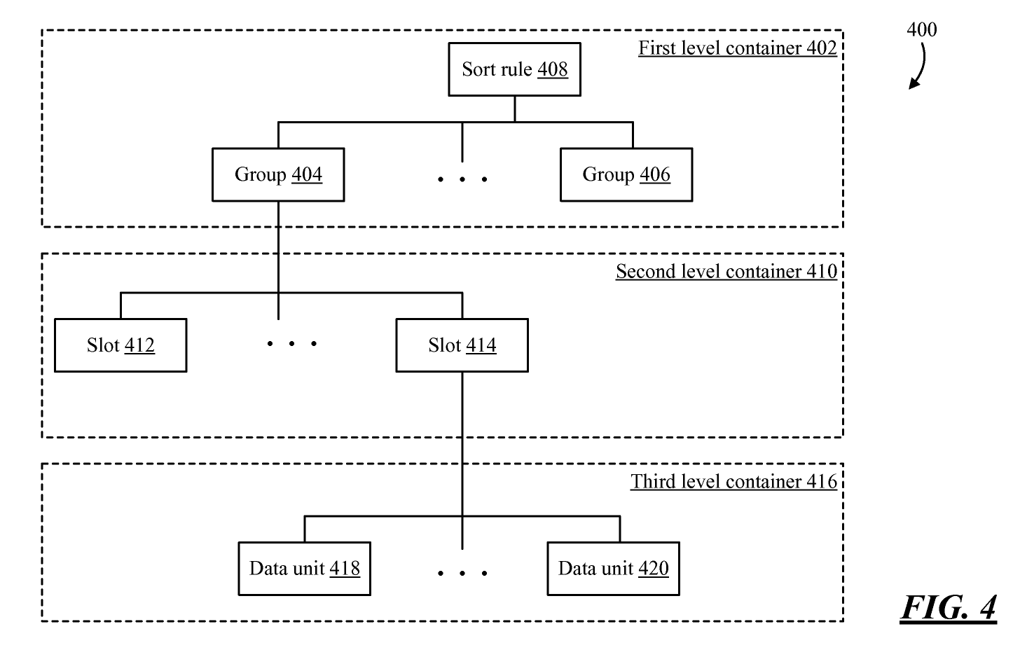

FIG. 4 shows an example container structure 400 that may be used by UI controls 316 (shown in FIG. 3), in order to organize information on a timeline. Example container structure 400 may be used by either the full timeline or mini timeline.

A first level container 402 comprises groups of data, such as group 404, group 406, etc. The actual number of groups, and the ranges of time that each group represents may be configurable. Additionally, the groups may use a configurable sort rule 408 that determines how data are to be sorted within a group.

A second level container 410 comprises slots of data. As described above, the relationship between groups and slots is that a group may be sub-divided into one or more slots, as in the example where group=year and slot=quarter. Thus, group 404 comprises slot 412, slot 414, etc. Similarly, group 406 may be divided into slots. The actual number of slots into which a group is to be divided may be configurable.

A third level container 416 comprises the individual data units that fall into the slots and groups. For example, in the medical records example described above, the record of each medical test (e.g., a particular CT scan, a particular MR scan, etc.) may be a data unit. In the example of FIG. 4, data units 418 and 420 are shown in container 416, where data units 418 and 420 both fall into slot 414. Each slot may have zero or more data units that fall into that slot.

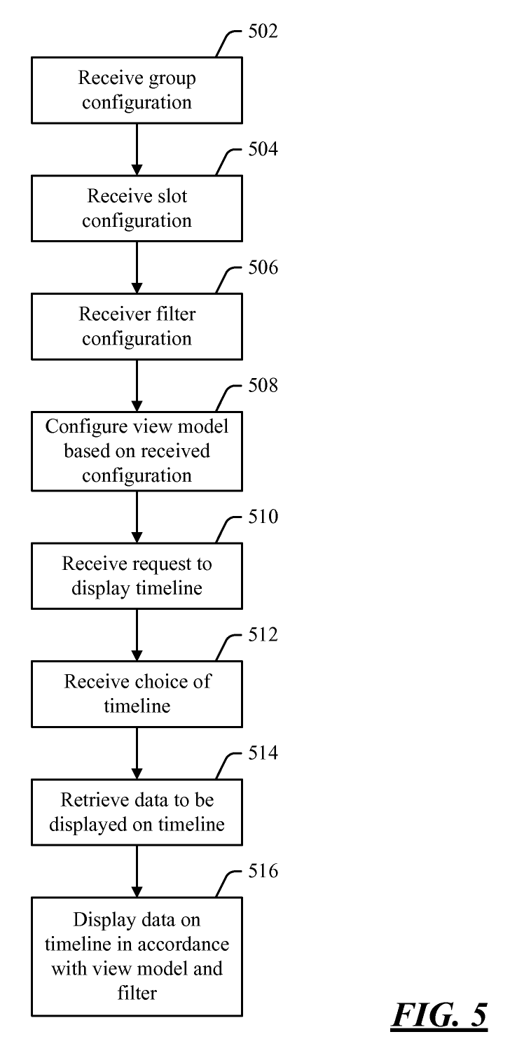

FIG. 5 shows an example process in which a timeline may be configured and/or shown. Before turning to a description of FIG. 5, it is noted that the flow diagram shown in FIG. 5 is described, by way of example, with reference to components shown in FIGS. 1-4, although this process may be carried out in any system and is not limited to the scenarios shown in FIGS. 1-4. Additionally, the flow diagram in FIG. 5 shows an example in which stages of a process are carried out in a particular order, as indicated by the lines connecting the blocks, but the various stages shown in this diagram can be performed in any order, or in any combination or sub-combination.

At 502, a group configuration may be received. For example, a user or other person may specify what range of time (e.g., decade, year, month, etc.) constitutes a group. At 504, a slot configuration may be received. For example, a user may specify what range of time constitutes a slot. Thus, if a group is a year, then a slot may be configured to be a quarter or a month. If a group is a decade, then a slot may be configured to be a year. Other appropriate combinations of ranges also could be used for groups and slots.

At 506, a specification of a filter configuration may be received. For example, as shown in the medical test example of FIG. 1, a user may be able to check boxes indicating which medical tests are to be shown on a timeline and which ones are not to be shown. This choice defines a filter, which is used to determine which data records to represent on the timeline.

At 508, the view model is configured based on the configurations that were received at 502-506. Thus, the view model may be configured to represent a user's choice of group, slot, filter, etc.

At 510, a request is received to display a timeline. For example, a user may indicate (through a menu, through text commands, etc.) that a timeline is to be displayed. At 512, the user specifies a choice of timeline—e.g., a full timeline, a mini-timeline, etc. The actual request to display a timeline and the choice of timeline format may be explicit or implicit. For example, if the user is using a medical data application, the fact that a window is open for this application may simply cause a timeline to be displayed by default, and may cause a particular default format for the timeline to be chosen.

At 514, data to be displayed on the timeline is retrieved. For example, if each data unit is a record of a particular medical test, then the data to be displayed are records of those medical tests. The data may be stored in a database, and may be retrieved in order to display the data on a timeline. At 516, data is displayed on a timeline in accordance with the view and/or filter described above.

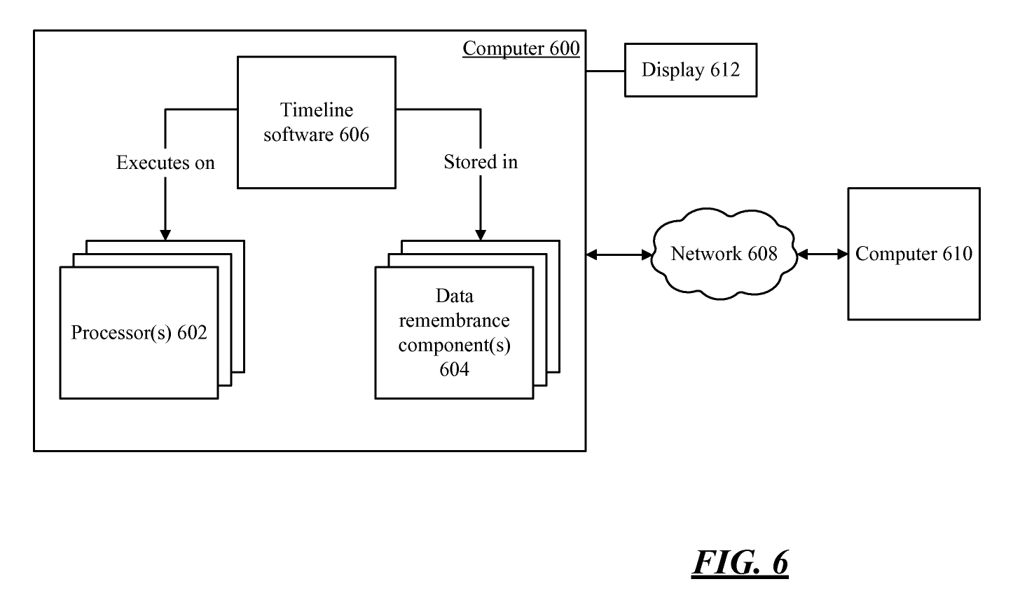

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is timeline software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store instructions that, when executed by a computer, cause the computer to perform acts comprising:
receiving a first configuration that specifies groups, wherein each of said groups represents a first category;
receiving a second configuration that specifies slots, wherein each of said slots represents a second category;
receiving a third configuration that specifies a filter;
receiving a request to display a timeline;
receiving a choice of a type of timeline to be displayed; and
displaying said timeline, which shows representations of data, wherein each piece of said data is associated with a date, wherein pieces of said data are selected to be shown on said timeline based on which of said data satisfy said filter, and wherein each of the selected pieces of data are shown on said timeline in a manner that reflects which of said groups and which of said slots the date associated with a given selected piece of data falls into.

2. The one or more computer-readable storage media of claim 1, wherein said first category represents a first range of time, and wherein said second category represents a second range of time that is smaller than said first range of time.

3. The one or more computer-readable storage media of claim 1, wherein a configurable sort rule is used to sort data within each of the slots.

4. The one or more computer-readable storage media of claim 1, wherein each piece of said data comprises a medical test that has been performed on a patient, and wherein said filter indicates that certain types of medical tests are to be shown on said timeline, and wherein said filter further indicates that certain types of medical tests are not to be shown on said timeline.

5. The one or more computer-readable storage media of claim 1, wherein said choice of said type of timeline comprises a choice between: (a) a full timeline view that represents the selected pieces of data in a first space, and (b) a mini-timeline view that represents the selected pieces of data in a second space that is smaller than said first space.

6. The one or more computer-readable storage media of claim 1, wherein said pieces of data are represented in a data model, wherein a manner in which said timeline is displayed is determined by a view model that is separate from said data model.

7. The one or more computer-readable storage media of claim 1, wherein said timeline shows a column for each of the slots, wherein each column contains representations of those selected pieces of data whose associated date falls within a range that corresponds to a given slot.

8. A method of showing data on a timeline, the method comprising:
using a processor to perform acts comprising:
receiving configuration information that specifies groups and slots, wherein each of said groups represents a first range of time, and wherein each of said slots represents a second range of time that is smaller than said first range of time;
receiving a specification of a filter that describes what kinds of data are to be shown on a timeline and what kinds of data are not to be shown on said timeline;
receiving a choice of a type of timeline to be displayed;
displaying said timeline, which shows representations of data, wherein each piece of said data is associated with a date, wherein pieces of said data are selected to be shown on said timeline based on which of said data satisfy said filter, and wherein each of the selected pieces of data are shown on said timeline in a manner that reflects which of said groups and which of said slots the date associated with a given selected piece of data falls into.

9. The method of claim 8, wherein each piece of said data comprises medical data that describes a human body of a patient, or that describes a physical test that has been performed on said human body.

10. The method of claim 8, where each of said groups represents a calendar year, and wherein each of said slots represents a calendar quarter.

11. The method of claim 8, wherein each piece of said data comprises a medical test that has been performed on a patient, and wherein said filter indicates that certain types of medical tests are to be shown on said timeline, and wherein said filter further indicates that certain types of medical tests are not to be shown on said timeline.

12. The method of claim 8, wherein said choice of said type of timeline comprises a choice between: (a) a full timeline view that represents the selected pieces of data in a first space, and (b) a mini-timeline view that represents the selected pieces of data in a second space that is smaller than said first space.

13. The method of claim 8, wherein said pieces of data are represented in a data model, wherein a manner in which said timeline is displayed is determined by a view model that is separate from said data model.

14. The method of claim 8, wherein said timeline shows a column for each of the slots, wherein each column contains representations of those selected pieces of data whose associated date falls within a range that corresponds to a given slot.

15. A system to display data on a timeline, the system comprising:
a processor;
a data remembrance component;
a timeline component that is stored in said data remembrance component and that executes on said processor, the timeline component receiving configuration information that specifies groups and slots, each of said groups representing a first range of time, each of said slots representing a second range of time that is smaller than said first range of time;
a filter component that receives a specification of which data are to be displayed and which data are not to be displayed; and
a user interface component that shows representations of data on a timeline, wherein each piece of said data is associated with a date, wherein pieces of said data are selected to be shown on said timeline based on which of said data satisfy said specification, and wherein each of the selected pieces of data are shown on said timeline in a manner that reflects which of said groups and which of said slots the date associated with a given selected piece of data falls into.

16. The system of claim 15, wherein each piece of said data comprises medical data that describes a human body of a patient, or that describes a physical test that has been performed on said human body.

17. The system of claim 15, where each of said groups represents a calendar year, and wherein each of said slots represents a calendar quarter.

18. The system of claim 15, wherein each piece of said data comprises a medical test that has been performed on a patient, and wherein said filter indicates that certain types of medical tests are to be shown on said timeline, and wherein said filter further indicates that certain types of medical tests are not to be shown on said timeline.

19. The system of claim 15, wherein said pieces of data are represented in a data model, wherein a manner in which said timeline is displayed is determined by a view model that is separate from said data model.

20. The system of claim 19, wherein said timeline component configures said view model based on the configuration information and based on the specification of which data are to be displayed and which data are not to be displayed.
